(19) United States
(12) Patent Application Publication
(10) Pub. No.: US 2012/0154790 A1
(43) Pub. Date: Jun. 21, 2012

(54) APPARATUS, SYSTEM, AND METHOD FOR DETECTING CHEMICALS

(76) Inventor: Gary Bodily, Logan, UT (US)

(21) Appl. No.: 12/052,572

(22) Filed: Mar. 20, 2008

Related U.S. Application Data
(60) Provisional application No. 60/895,884, filed on Mar. 20, 2007.

(51) Int. Cl. G01J 3/28; G01N 21/55; G01J 3/10

(52) U.S. Cl. 356/51; 356/300; 356/317

(57) ABSTRACT

An apparatus, system, and method for detecting chemicals utilizes a mechanism for dividing light from a target volume into different frequency bands and directing these bands onto a pixel array. The entire pixel array is then read out at essentially the same time. Dividing and applying the ranges of frequencies to the pixels in this way facilitates decoupling spectral information from the data signals and determining a spectral range signature without aliasing. Analysis of the spectral range signature and other spectral information including comparison to a database enables identification of chemical(s) in a target volume. The system and apparatus may include a chemical detector having a light collector, a diffraction grating, a focal plane array of pixels, and a controller. A light generator and a high frequency microphone for receiving a photoacoustic response may be utilized to determine a location of a material in the target volume.

### CROSS-REFERENCES TO RELATED APPLICATIONS

This application is a continuation-in-part of and claims priority to United States Provisional Patent Application Number 60/895,884 entitled APPARATUS, SYSTEM, AND METHOD FOR DETECTING AIRBORNE CHEMICALS and filed on Mar. 20, 2007 for Gary Bodily, which is incorporated herein by reference.

### BACKGROUND OF THE INVENTION

1. Field of the Invention

This invention relates to devices for detecting chemicals and more particularly relates to photo spectrometers for detecting and identifying chemicals based on spectral signatures.

2. Description of the Related Art

Spectrometers have been developed for scanning a spectrum of light from an area of interest in an effort to detect and identify airborne particles based on spectral signatures. Some of these spectrometers utilize specialized algorithms to deal with the wide variety of spectra that is typically present in atmospheric conditions. The algorithms are configured to identify spectral signatures as much as possible with signal data from environments that yield much time-wise variation in the data. Often, it is difficult to derive meaningful information about airborne materials of interest in the area of interest due to poor quality in the signal data.

### SUMMARY OF THE INVENTION

From the foregoing discussion, it should be apparent that a need exists for an apparatus, system, and method that among other things, detects gases or other airborne particles in the atmosphere where there are constant changes in the environment and in the concentration of the materials of interest. Beneficially, such an apparatus, system, and method would detect and identify the materials without the negative affects of aliasing.

The present invention has been developed in response to the present state of the art, and in particular, in response to the problems and needs in the art that have not yet been fully solved by currently available spectrometers and other chemical detectors. Accordingly, the present invention has been developed to provide an apparatus, system, and method for detecting chemicals in the atmosphere, other dynamically changing environments, or any volume of interest that overcome many or all of the above-discussed shortcomings in the art.

Embodiments of the method may further include utilization of numerical methods to improve detection, identification, and quantification of materials of interest. The numerical methods are valuable because other aspects of the invention remove fluctuations in the data being sampled by separating the collected light into multiple bins of respective frequencies or ranges of frequencies all of which are collected at substantially an instant in time so that aliasing of the data to be analyzed is avoided. That is, improved estimation of the materials through numerical methods is made possible by avoiding aliasing in accordance with embodiments of the present invention. Other embodiments include improved location of the materials of interest.

In one aspect of the invention, the apparatus for detecting chemicals in accordance with embodiments of the invention is provided with a plurality of modules at least one of which is configured to functionally execute the necessary step of determining one of an unknown spectra and an identified chemical based on chemical spectral information and a spectral database.

In a simple form, an embodiment of the apparatus and system of the present invention include a chemical detector. The chemical detector has a light collector configured to gather light from a volume of interest and a light separator configured to apply a plurality of frequency ranges of the light onto a plurality of pixels of a pixel grid according to a pixel-frequency map. The pixel grid includes a photo-sensitive array of photodetectors and generates a plurality of response signals. The chemical detector also has a controller with a chemical identifier module configured to determine one of an unknown spectra and an identified chemical based on chemical spectral information and a spectral database.

The controller may include a decoupling module configured to decouple the plurality of response signals to determine groups of frequency signatures utilizing the pixel-frequency map. The controller may also have a spectral identification module configured to determine one or more of background, chemical, and noise spectral information from the groups of frequency signatures.

In one embodiment, the chemical detector includes a light generator associated with the light collector. The light generator is configured to direct light into a volume of interest to thereby transmit energy into the volume of interest. In this embodiment, at least one high frequency microphone is operably connected to the chemical detector. The high frequency microphone is configured to detect a photoacoustic response from the volume when light from the light generator is directed into the volume. In this embodiment, a controller may further include an infrared (IR) stimulation module configured to control an IR lamp with an IR beam command. The controller may also have a location module configured to determine a location for the identified chemical based on a photoacoustic response, whether the chemical is in a form of a cloud of gas or a solid.

In another simple form, an embodiment of the invention includes a system or combination of a chemical detector and a location detector. The combination may include a light collector configured to gather light from a volume of interest and a light separator configured to apply frequency ranges of the light onto one or more pixels having at least one photo-sensitive photodetector. The one or more pixels generate a response signal. The combination also includes a light generator associated with the light collector. The light generator is configured to direct light into the volume of interest in order to transmit energy into the volume. In this embodiment, at least one high frequency microphone is configured to detect a photoacoustic response from the volume when light from the light generator is directed into the volume. A controller has a stimulation module that is configured to control the light generator when the chemical detector identifies at least one predetermined chemical. The controller also has a location module that is configured to determine a location for the identified chemical based on the photoacoustic response.

In another simple form, a method for detecting a chemical through light spectral signatures in accordance with another embodiment of the invention includes collecting light from a volume of interest and applying predetermined frequency spectrum ranges of the light to predetermined pixels. The method also includes identifying at least one chemical that is present in the volume. The method may include avoiding aliasing of data by capturing the data signals in a majority of the pixels for substantially the same instant in time. An instant in time may be defined such that if the light on a pixel is the total of the light that falls on that detector for the time period T1 to T2 then all pixels receiving data signals in this particular snapshot will receive data signals representing the same time period T1 to T2. The method in the disclosed embodiments includes the steps that may be used to carry out the functions presented above with respect to the operation of the described apparatus and system. However, the method may alternatively be carried out with different apparatuses and systems.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an illustration depicting one embodiment of a system to detect airborne and other chemicals in accordance with the present invention;

FIG. 2 is an illustration depicting one embodiment of an chemical detector 108 in accordance with the present invention;

FIG. 3 is a schematic block diagram illustrating one embodiment of a controller to detect and locate airborne and other chemicals in accordance with the present invention;

FIG. 4A is a schematic flow diagram illustrating one embodiment of a method for detecting airborne and other chemicals in accordance with the present invention; and

FIG. 4B is a continuing schematic flow diagram illustrating one embodiment of a method for detecting chemicals in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, hardware modules, hardware components and devices, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

An apparatus and system configured for detecting chemicals in accordance with the present invention utilize a mechanism for dividing light from a target volume into a diffracted or otherwise separated spectra of light. The light may be separated based on ranges of frequencies and/or spatially separated, but not temporally separated for a given snapshot. The data is separated by frequency range and spatially in order to apply data signals associated with the frequency ranges collected at an instant in time to predetermined pixels in a pixel array. Dividing and applying the ranges of frequencies to the pixels in this way avoids aliasing and maintains data signal integrity because there is no mismatch between times that the data for the various ranges of frequencies were taken. Therefore, a chemical may be detected and identified based on spectral range signatures that are based on unaliased data signals.

Dividing and applying the ranges of frequencies to the pixels in this way and taking more than one snapshot also facilitate decoupling spectral information from the data signals and determining a spectral range signature. Analysis of the spectral range signature and other spectral information including comparison to a database enables identification of chemical(s) in a target volume.

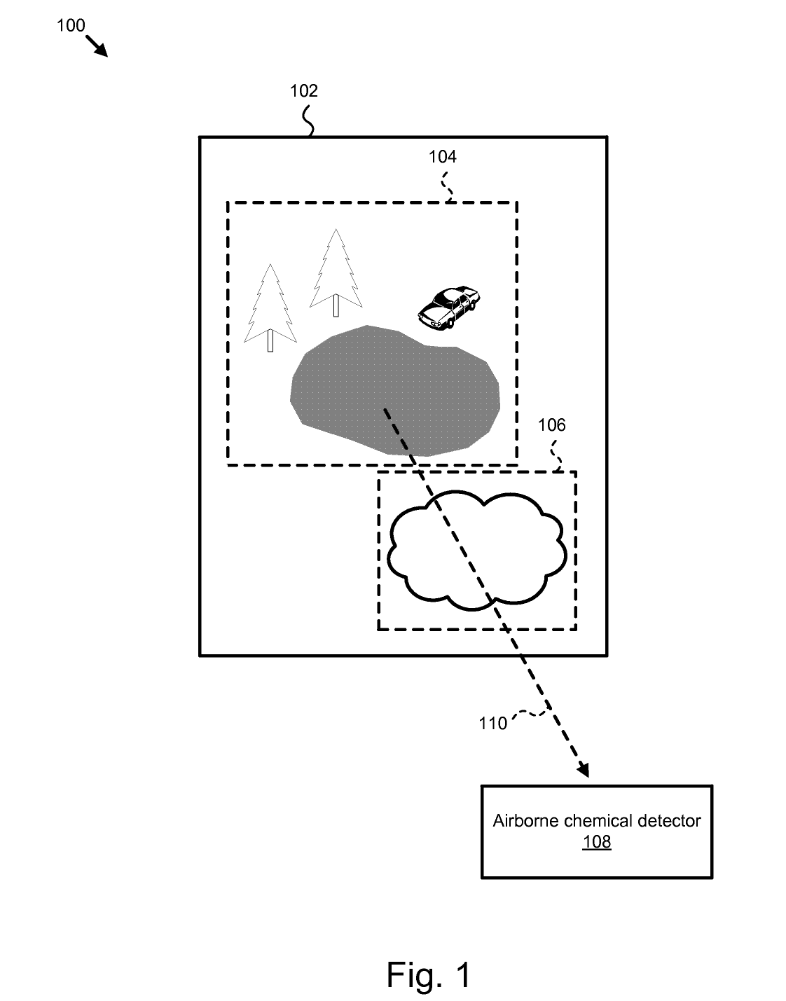

FIG. 1 is an illustration depicting one embodiment of a system 100 to detect chemicals in accordance with the present invention. The system 100 may include an area of interest 102 for airborne chemical detection. For example, an area of interest 102 may be an outdoor space or volume of interest 102 such as a portion of the atmosphere above a park, parking lot, airport tarmac, sports stadium, and/or battlefield. The area of interest 102 may also be an indoor area or volume of interest 102 such as in a police station, school, airport terminal, government office, auditorium, sports complex, and/or military installation. In these cases, the chemical detector is a stand off chemical detector. Alternatively, the area of interest may be a volume within a container or may include a gas or other fluid pulsed through a relatively small tube. Further alternatively, the area of interest may include a material deposited as a solid matrix on a substrate. In these cases, the detector may be considered a point chemical detector that is in contact with a container or other supporting structure for a material of interest.

The system 100 further comprises a background 104. The background 104 may be a portion of the area of interest 102 comprising relatively stationary objects within the observation range of an chemical detector 108. For example, the buildings, trees, and similar objects around the chemical detector 108 make up the background 104. Further, vehicles and other intermittently mobile objects can make up the background 104 over periods of time. For example, a vehicle parked by they chemical detector 108 for thirty minutes will be a member of the background 104 for that period.

The system 100 may further comprise an chemical 106 and/or other material within the area of interest 102. The chemical 106 may be a hazardous chemical 106 and/or other chemical 106 of interest. For example, the chemical 106 may be a hazardous material, an illegal material, an industrial chemical, a material of scientific interest, a benign material, any naturally occurring material, and similar materials in the area of interest 102. Several chemical clouds may be present simultaneously, and/or a single cloud may comprise multiple chemicals. In the context of point detection, the chemical may be held in a container with an inert gas, may be sampled in a flow through configuration, or may be deposited as a solid matrix on a substrate.

The system 100 further comprises an chemical detector 108 configured to interpret the spectrum of light 110 received from the area of interest 102, including the infrared (IR) spectrum. The chemical detector 108 may parse the spectral signature of the light 110 to determine the background 104 contribution to the spectrum and the chemical 106 contribution to the spectrum. The system 100 may include several chemicals 106, and the chemical detector 108 may determine the contribution of each chemical 106 to the spectrum of the received light. It is to be noted that although reference to IR is made throughout the specification, radiation or light in other frequency ranges may be included with or substituted for the IR referred to depending on the application. For example UV, visible light, radio frequency radiation, etc. can all be utilized in addition to or in place of RF radiation if valuable information is present in these frequency ranges.

The chemical detector 108 may be an airborne chemical detector and may be further configured to determine the direction and/or distance of the chemical 106 within the area of interest 102 based on a photoacoustic response. Alternatively, the chemical detector 108 is not necessarily an airborne chemical detector, but may be a chemical detector 108 for detecting a chemical or other material in an enclosed volume or the chemical or material in a solid matrix supported on a substrate, for example. In any case, in one embodiment, the chemical detector 108 emits an intermittent infrared (IR) flash into the area of interest 102. The IR flashes cause slight heating of the chemicals present thus producing an acoustic responses by the chemical 106, which the chemical detector 108 uses to locate the chemical 106, whether it be in a form of a cloud of gas or vapor, particles, or a solid. Hence, a photoacoustic response can be used to locate or confirm a position of a cloud of gas or a deposit of solid material.

An alternative or additional mechanism for developing a size and position estimation is to use several IR detectors at different locations. If the detectors are placed correctly we can determine the location of the different chemicals by triangulation.

Whether separate or in combination with a chemical detector, the location detector may include a light generator that has an infrared (IR) beam generator and a stimulation module operated by a controller. The stimulation module may be configured to control the IR generator in the form of an IR lamp with an IR beam command.

It is to be understood that a photoacoustic location mechanism or detector as described herein may be combined with the chemical detectors of the present invention or with known chemical detectors to incorporate the advantages associated with the location mechanism. A combination chemical detector and location detector may include one, two, three or more high frequency microphones. In one embodiment, the location detector has more than three high frequencies microphones.

In one embodiment, the chemical detector 108 has a catalog of chemical spectral properties. The chemical detector 108 may use the catalog of chemical spectral properties to identify detected chemicals 106. The chemical detector 108 may identify chemicals 106 as chemicals of interest, and/or as neutral chemicals. In one embodiment, the chemical detector 108 may capture and store unknown chemical spectra for later analysis.

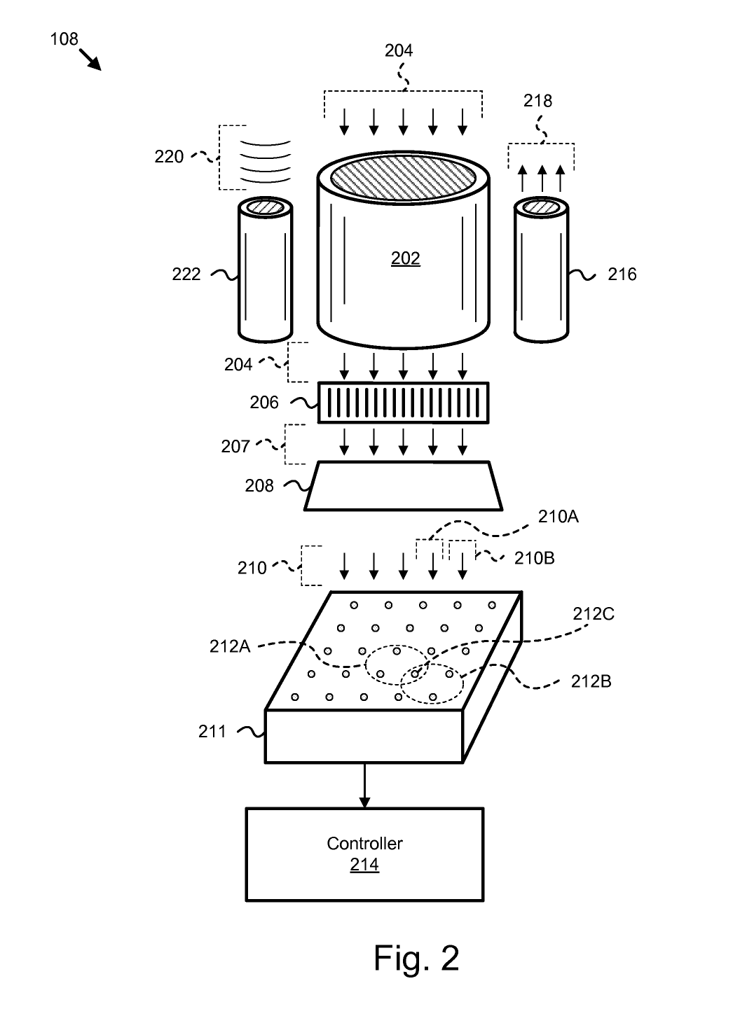

FIG. 2 is an illustration depicting one embodiment of an chemical detector 108 in accordance with the present invention. FIG. 2 shows an exploded, abstracted representation of parts of the chemical detector 108 in accordance with one embodiment of the present invention. In this embodiment, the chemical detector 108 has a light collector 202 configured to collect a light spectrum 204 by use of a lens, minor, and/or other light collecting device. The light collector 202 may direct the radiation 204 from the area of interest 102, including the IR spectrum, through a light dispersing element 206 configured to divide the radiation 204 spectrum into component frequency elements 207, or frequency ranges of the radiation 204 spectrum. In one embodiment the light dispersing element 206 is a diffraction grating 206. In alternate embodiments, the light dispersing element 206 may be a prism, reflective diffraction grating, or other such device configured to divide light from spectrum 204 into component frequency elements 207. The component frequency elements 207 may comprise selected frequency ranges of the spectrum 204, evenly spaced frequency ranges of the spectrum, and/or frequency ranges organized by any criteria selected.

The chemical detector 108 may further comprise a complex diffraction grating 208 configured to translate the one dimensional component frequency elements 207 of the light dispersing element 206 onto predetermined locations on a two dimensional light receiving grid 211. One method of configuring this complex diffraction grating is to utilize a computer generated holography (CGH), although other methods of configuring the diffraction grating 208 are also within the scope of the present invention. In one embodiment, the light dispersing element 206 and the diffraction grating 208 may be replaced by a single component of the chemical detector 108. The selection of a light dispersing element 206 and/or CGH 208 is one way to accomplish dividing the light into spectra and directing that light onto predetermined locations of the receiving grid 211 in accordance with embodiments of the present invention. Alternative methods for generating the spectra may include doing so by a specially configured diffraction grating 208 that is configured to direct light of specific frequency ranges onto specific locations of the receiving grid for detection by predetermined photosensing elements such as elements in a pixel array of the receiving grid. Other methods are also within the scope of the present invention. For example, the chemical detector 108 can be practiced without the use of a diffraction grating 208, although there may be some impact to the size of the receiving grid 211 and the overall device 208. That is, the receiving grid would need to be larger for equivalent capability and performance of the chemical detector 108. Alternatively, any light collecting system that introduces chromatic aberration may be used. Some systems will separate the light better than other systems, and the cost/size of the configuration will also vary. Nevertheless, in general, any chromatic aberration system may be used.

The light receiving grid 211 may include the photosensing elements or pixels. For example, a focal plane array of the pixels may be configured to receive the component frequency elements 210. In one embodiment the diffraction grating 208 may be configured to beam specific component frequency elements 210 onto specific pixels of the light receiving grid 211. In one embodiment, the diffraction grating 208 places specific component frequency elements 210A, 210B onto overlapping pixels 212A, 212B. Frequency range 210A may correspond to pixels 212A while frequency range 210B may correspond to pixels 212B. In any case, one or both of the light dispersing element 206 and the diffraction grating 208 may be considered to be a light separator and may be utilized to separate light spectrally by frequencies and/or spatially.

The use of a grid 211 with the photosensing elements for detecting overlapping frequencies allows for easier construction of the detector 108 and with numeric decoupling of the overlapping frequencies allows the grid 211 to have a lower number of pixels 212 to simulate a grid 211 with a larger number of pixels 212. In one embodiment, the frequency ranges 210 and pixels 212 are related in a many-to-many relationship, and they can be separated with a matrix multiplication operation to determine a solution for each frequency range 210 that explains the observed measurements on the pixels 212. For example, the numeric decoupling procedure may include a Haddamard transform or related method. In one embodiment, the numerical method measures the frequency response of the detector and determines exactly where each frequency is mapped, and then develops a matrix that will take the pixel data and by matrix multiplication generate an estimate of the spectra.

Often the data is most useful when expressed as a frequency since frequency is directly proportional to energy. A measure of frequency is the wave number. For example, a 7 μm is equivalent to 1400 cm⁻¹ and 14 μm is equivalent to 700 cm⁻¹, or the width of the spectra 700 cm⁻¹. If we separate the spectra into 1000 equally spaced wave numbers each space is equal to 0.7 cm⁻¹. So all the energy from 700 cm⁻¹ to 700.7 cm⁻¹ can be allocated to one spectral bin and labeled 700 cm. To construct these spectra, a controller 214 takes signals from the pixels and maps them into the spectral bins. To take a snapshot of a spectra in accordance with embodiments of the present invention, there needs to be at least as many pixels as bins. That is, the number of spectral bins is the theoretical lower limit for the number of pixels. More pixels per bin allow for better estimation of the energy represented in each bin and allows for a reduction in noise. Thus, in many cases, it is advisable to use many more pixels than bins.

If a spectra of 1000 frequency ranges 210 is required, at least 1000 pixels are needed to capture the entire spectral range in a single capture event, where the single capture event may be a single execution cycle of the controller 214, for example. In this example, providing 1000 pixels is only the theoretically lower limit, and a better estimate can be obtained by using more pixels. For example, using 2000 pixels to capture 1000 frequency ranges 210 would enable values of signals received by two pixels to be analyzed and a better estimated value placed in a corresponding frequency bin. As may be appreciated, with even more pixels receiving signals for a given range of frequencies, the estimate of the value can be further improved and the noise can be better reduced. Many current and past IR detectors use fewer pixels than this, sometimes only one pixel for receiving signals representing multiple frequencies or ranges of frequencies. If fewer pixels 212 are used than there are frequency ranges 210 of interest, then multiple snapshots over a period of time must be taken of the area of interest 102, and the time lag between the first snapshot and the last snapshot allows for changes (which introduces aliasing) in a chemical 106 concentration detected that may obfuscate the picture of the chemical 106 and background 104, or may cause present chemicals 106 to be missed. Therefore, embodiments of the present invention incorporate at least as many pixels as there are spectral bins and corresponding ranges of frequencies of interest.

In another embodiment of the invention, plural snapshots may be taken during a single capture event. Some advantages are still available even where multiple snapshots of the area of interest 102 are required. For example, certain aspects of embodiments of the invention may be used to reduce the number of snapshots required to take a complete reading of the spectrum of interest. In this regard, embodiments of the invention may utilize frequency range overlap on pixels and numeric decoupling techniques in order to identify signature frequency ranges even though a full spectrum is not obtained in a single snapshot and/or even when a complete overlap with all frequency ranges 210 is not achieved.

Even though multiple snapshot may be taken for a single capture event, each snapshot can still capture signal data for all frequency ranges of interest that are present at the instant the snapshot is taken.

The chemical detector 108 further includes the controller 214 that interprets the spectral information and the pixel map from the pixel array 211 and determines whether a chemical 106 is present in the area of interest 102. In one embodiment, if a chemical 106 is present in the target area 102 the controller 214 may generate a locate signal. In one embodiment, the locate signal triggers an IR pulse generator 216 to flash repeatedly. The chemical 106 absorbs the IR pulse energy each time the IR pulse generator 216 flashes, causing heating and cooling cycles in the chemical 106 which emit a photoacoustic response 220 detectible by a high frequency microphone 222. The controller 214 may determine the direction and/or distance of the chemical 106 from the chemical detector 108 by use of triangulation, time lapse, or some other method. The microphones and photoacoustic portions of the system 100 need not be within the same chemical detector 108. The combination may be advantageous from a communication and space-saving standpoint, but the separation of these functions and the structures to perform these functions is contemplated to be within the scope of the present invention. Likewise, the IR pulse generator 216 may comprise more than one IR pulse generator, and may be configured to support the chemical detection and/or chemical location functions of the present invention.

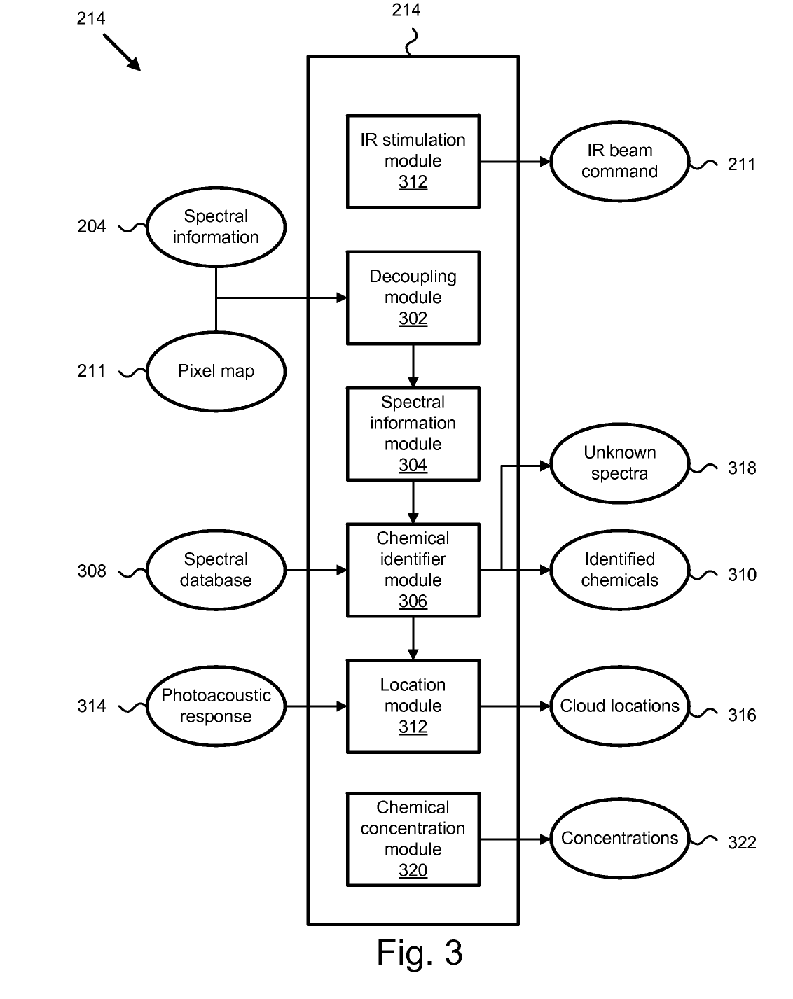

FIG. 3 is a schematic block diagram illustrating one embodiment of a controller 214 to detect and locate airborne chemicals 106 in accordance with the present invention. When the chemical or other material of interest is isolated within a container or in a solid supported on a substrate, the controller can still locate the chemical or other material. The controller 214 may comprise a decoupling module 302 configured to interpret the spectral information 204 and the pixel map 211. The decoupling module 302 determines the signature of each frequency range 210 by calculating the contribution of each frequency range 210 to signals received by the pixels 212 that the frequency range 210 affects using numerical methods as described in the description referencing FIG. 2.

The controller 214 further comprises a spectral identification module 304 configured to interpret the signatures from each frequency range 210 determined by the decoupling module 302, and determine patterns in the frequencies present in the area of interest 102. The spectral identification module 304 may correlate these patterns to patterns in known spectra. Thus, the spectral identification module 304 can perform a correlation method by any of a variety of known or yet undiscovered methods of pattern matching methods. In addition, a set of snapshots can be processed to separate different spectra from each other.

In the present context, principal component analysis (PCA) comprises determining the largest group of frequency signatures that correlate together, and determining each other important group of frequency signatures that correlate together in order of decreasing magnitude. In one embodiment, the largest group of frequency signatures that correlate together comprises the background 104, and any other important groups of frequency signatures that correlate together will comprise one or more chemicals 106. Any leftover frequency signatures generally do not correlate together, may be completely random, and/or may include noise. Thus PCA not only separates background and cloud spectra or other spectra of interest, but also is a powerful noise reduction schema.

The controller 214 further comprises a chemical identifier module 306 configured to read the groups of frequency signatures from the spectral identification module 304. The chemical identifier module 306 compares each group of frequency signatures with a spectral database 308 of chemicals of interest. If the chemical identifier module 306 matches a group of frequency signatures with a frequency pattern in the spectral database 308 then the chemical identifier module 306 may generate an identified chemical signal 310.

In one embodiment, the chemical identifier module 306 may ignore the largest group of frequency signatures because the largest group may represent the background 302. The chemical identifier module 306 may find multiple chemicals 106 within a group of frequency signatures by identifying a chemical 106 from the spectral database 308 that includes a portion of the group of frequency signatures, subtracting the signature of the identified chemical 106, and checking the remainder of the group of frequency signatures against the spectral database 308 to find more chemicals 106 indicated by the signal.

In one embodiment, the chemical identifier module 306 stores an unknown spectra 318. For example, a group of frequency signatures may not match any chemical in the spectral database 308, and the chemical identifier module 306 may save the group of frequency signatures as an unknown spectra 318. The chemical identifier module 306 may additionally notify other parts of the system 100, and/or set a control flag based on finding an identified chemical 310 or an unknown spectra 318.

The controller 214 may further comprise a location module 312 configured to locate an identified chemical 310. The location module 312 may receive a control flag from the chemical identifier module 306 and a photoacoustic response signal 314 from the microphone(s) 222. For example, the location module 312 may be configured to read the control flag supplied by the chemical identifier module 306, and determine a location 316 of a chemical in a cloud or other material form when a chemical is detected. The location module 312 may determine the location 316, which may be a distance and/or a direction, based on multiple photoacoustic signals 314. For example, the photoacoustic response 314 may comprise inputs from three or more microphones, and the location module 312 may determine the location 316 from the inputs of the three or more microphones.

The controller 214 may further comprise a chemical concentration module 320 that calculates concentrations 322 of the one or more detected chemical clouds 106. The chemical concentration module 320 may utilize the cloud locations 316 and/or other information from the system 100 to determine the concentration 322. In one embodiment, the chemical concentration module 320 estimates the cloud size, cloud distance, cloud angle of view to the detector 108, the percentage of the area of interest 102 filled by the cloud, and/or other information that may be useful in estimating the chemical concentrations 322. The chemical concentration module 320 may utilize the cloud location 316 and the spectral information 204 over a period of time to determine these parameters.

Such data can be used directly to estimate the chemical concentration 322, and/or can be combined with pre-programmed information describing the background, and with information from multiple detectors 108. In one embodiment, the controller 214 may be configured to increase a sampling rate of spectral information 204 to support faster spectral information 104. The extra snap shots improve the performance of the PCA and help separate the various spectra from each other. These additional features can provide added benefits to the various embodiments of the invention. For example, they may enable determining chemical concentrations 322 while preserving resources (e.g. processor usage in the controller 214 and/or a power supply such as a battery) when faster spectral information 104 is not required.

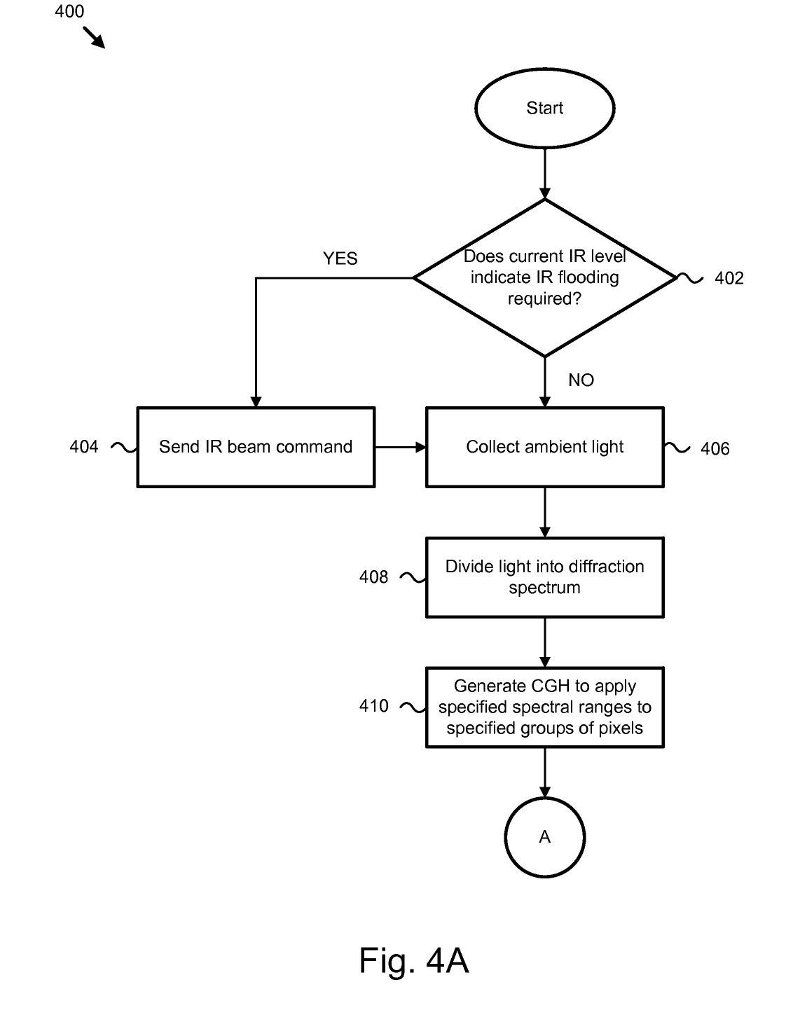

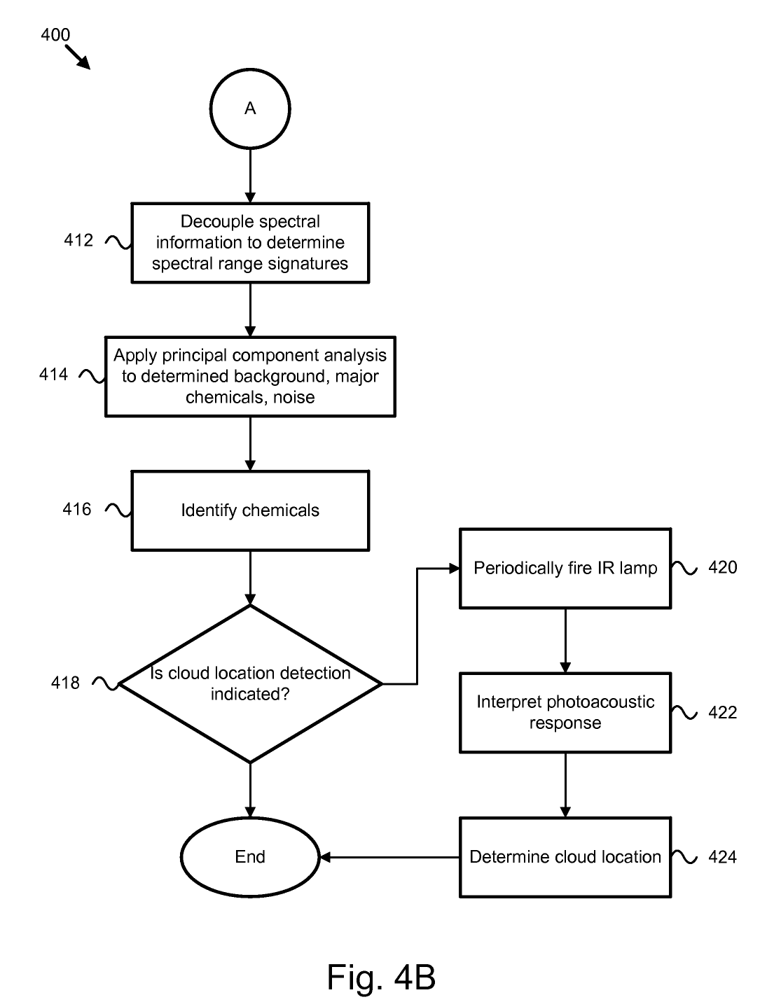

FIG. 4A is a schematic flow diagram illustrating one embodiment of a method 400 for detecting airborne and non-airborne chemicals 106 in accordance with the present invention. The method 400 comprises an IR stimulation module 312 determining whether an area of interest 102 requires IR flooding to increase the intensity of IR frequency waves available to the light collector 202. For example, the controller 214 may determine based on a signal emitted from the IR collector 202 that the IR intensity detected does not meet a certain threshold. Thus, the controller 214 sends an IR beam command 404 to an IR lamp 216 to flood the area of interest 102 with IR light.

The method 400 comprises a light collector 202 collecting 406 ambient light, which may include any residuals from IR light added artificially, from the area of interest 102. The method 400 continues with a light dispersing element 206 dividing 408 the light into a diffraction spectrum 207. A diffraction grating 208 transforms the spectrum into component frequency elements 210, and applies 410 specified spectral ranges 210 to specified groups of pixels 212. The method 400 is not limited to dividing or separating the light into a diffraction spectrum such as by a diffraction grid. Rather any of a variety of devices for separating the light into predetermined frequencies or ranges of frequency spectra may be utilized. For example, a prism, lens, or computer generated holograph could be utilized to separate the light by frequencies and/or spatially. Once separated, the predetermined frequency spectra ranges of the light can be applied to predetermined pixels.

Because the light is separated and directed to predetermined pixels based on predetermined frequencies or ranges of frequencies in a snapshot representing a single moment in time, the method also includes maintaining an integrity of the signal data or avoiding aliasing of the data. The method includes capturing the data signals in a majority of the pixels for substantially an instant in time. Hence, the methodology may be termed snapshot acquisition methodology (SSAM). The method may include taking plural such snapshots, which multiplies the data and is useful for processing and decoupling the data through numerical analysis methods. The numerical methods integrate the data signals to provide an estimate of materials in the volume of interest. It is to be understood that data signals may be collected during a long or short period of time in any given snapshot. However, to maintain the integrity of the data, the collection time for signals sent to the predetermined pixels must be substantially the same. The degree to which the times vary for the different data signals, aliasing will be introduced. While some aliasing is permissible for some applications, too much aliasing ruins the data and inhibits determination of the chemical of interest.

FIG. 4B is a continuing schematic flow diagram illustrating one embodiment of a method 400 for detecting chemicals 106 in accordance with embodiments of the present invention. Generally, the method 400 further includes processing data signals from the predetermined pixels to determine at least one spectral range signature. Specifically, the method 400 may continue with a decoupling module 302 for mathematically decoupling 412 the spectral information 204 contained in the groups of pixels 212 in the pixel map 211 to determine spectral range signatures. Thus, processing the signals from the predetermined pixels may include decoupling spectral information from data signals received by the pixels. In one case, the method 400 utilizes a spectral identification module 304 to apply principal component analysis (PCA) 414 to determine groups of frequency signatures, and thereby determine the background 102, chemicals 106, and noise components of the spectral information 204. The chemical identifier module 306 identifies 416 major chemicals 106 of interest by comparing the groups of frequency signatures with a spectral database 308.

The location module 312 checks 418 if a location detection is indicated. For example, a location detection may be indicated when an identified chemical 310 is present. If a location detection is indicated, the IR stimulation module 312 may periodically fire 420 the IR lamp 216 with the IR beam command 404. Ambient light is already available and is received by the pixels for each snapshot. The periodic firing 420 of the IR lamp adds artificial light to the volume of interest before or during the step of collecting the ambient light. Alternatively stated, the method may include intermittently adding light (such as IR or other light) to the ambient light. The method 400 may further include detecting a photoacoustic response from the volume of interest and interpreting 422 the photoacoustic response. Interpreting the photoacoustic response may further include determining a location 424 of a material within the volume of interest. Specifically, the location module 312 interprets 422 the photoacoustic response 220, and determines 424 the location 316 of a cloud or other material form of a chemical of interest according to the photoacoustic response 220. A chemical 106 location may be determined 424 through triangulation, timing pulses, or some other method.

The present invention may be embodied in other specific forms without departing from its spirit or essential characteristics. The described embodiments are to be considered in all respects only as illustrative and not restrictive. For example, while the term “cloud” has been utilized herein to describe a cloud of gas or airborne particles, it is to be understood that for purposes of this disclosure the term “cloud” is not limited to gases or airborne particles, but may include solids or portions of solid, dust, particles, liquids, and/or vapors. Also, while the specification refers to radiation that is pertinent to embodiments of the present invention as “light”, it is to be understood that the term “light” as used herein is defined as radiation in any range of frequencies whether visible or not. Accordingly, the scope of the invention is, therefore, indicated by the appended claims and is not to be limited by the foregoing description. All changes which come within the meaning and range of equivalency of the claims are to be embraced within their scope.

What is claimed is:

1. An chemical detector comprising:
a light collector configured to gather light from a volume of interest;
a light separator configured to apply a plurality of frequency ranges of the light onto a plurality of pixels of a pixel grid according to a pixel-frequency map, the pixel grid comprising a photo-sensitive array of photodetectors, wherein the pixel grid generates a plurality of response signals; and
a controller comprising a chemical identifier module configured to determine one of an unknown spectra and an identified chemical based on chemical spectral information and a spectral database.

2. The chemical detector of claim 1, wherein the plurality of pixels comprises a number equal to or greater than a number of the plurality of frequency ranges.

3. The chemical detector of claim 1, wherein the controller further comprises a decoupling module configured to decouple the plurality of response signals to determine groups of frequency signatures utilizing the pixel-frequency map.

4. The chemical detector of claim 3, wherein the controller further comprises a spectral identification module configured to determine one or more of background, chemical, and noise spectral information from the groups of frequency signatures.

5. The chemical detector of claim 1, wherein the chemical detector is a standoff chemical detector for detecting airborne particles.

6. The chemical detector of claim 1, wherein the chemical detector comprises a sample container enclosing the volume in which a sample environment is controlled.

7. The chemical detector of claim 1, further comprising:
a light generator associated with the light collector, the light generator configured to direct light into the volume of interest to thereby transmit energy into the volume of interest; and
at least one high frequency microphone operably connected to the chemical detector, the at least one high frequency microphone configured to detect a photoacoustic response from the volume when light from the light generator is directed into the volume.

8. The chemical detector of claim 1, wherein the controller further comprises:
an infra-red (IR) stimulation module configured to control an IR lamp with an IR beam command; and
a location module configured to determine a location for the identified chemical based on a photoacoustic response.

9. A combination chemical detector and a location detector, comprising:
a light collector configured to gather light from a volume of interest;
a light separator configured to apply frequency ranges of the light onto one or more pixels having at least one photo-sensitive photodetector, wherein the one or more pixels generates a response signal;
a light generator associated with the light collector, the light generator configured to direct light into the volume of interest to thereby transmit energy thereto;
at least one high frequency microphone configured to detect a photoacoustic response from the volume when light from the light generator is directed into the volume; and
a controller comprising:
a stimulation module configured to control the light generator when the chemical detector identifies at least one predetermined chemical; and
a location module configured to determine a location for the identified chemical based on the photoacoustic response.

10. The combination chemical detector and location detector of claim 9, wherein the at least one high frequency microphone is a first microphone of a plurality of high frequencies microphones.

11. The combination chemical detector and location detector of claim 9, wherein the light generator comprises an infrared beam generator and the stimulation module is configured to control an IR lamp with an IR beam command.

12. A method for detecting a chemical through light spectral signatures, the method comprising:
collecting light from a volume of interest;
applying predetermined frequency spectrum ranges of the light to predetermined pixels; and
identifying at least one chemical present in the volume.

13. The method of claim 12, further comprising avoiding aliasing of data by capturing the data signals in a majority of the pixels for substantially an instant in time.

14. The method of claim 12, wherein applying the predetermined frequency spectrum ranges of the light to the predetermined pixels comprises dividing the light into a diffracted spectrum.

15. The method of claim 12, wherein applying the predetermined frequency spectrum ranges of the light to the predetermined pixels comprises generating a computer generated holograph (CGH) and selecting the predetermined frequency ranges of the light from the CGH.

16. The method of claim 12, further comprising processing data signals from the predetermined pixels to determine at least one spectral range signature.

17. The method of claim 16, wherein processing the signals from the predetermined pixels comprises decoupling spectral information from data signals received by the pixels.

18. The method of claim 16, wherein processing the signals from the predetermined pixels comprises applying principle component analysis to determine one or more of background, major chemicals, and noise.

19. The method of claim 12, wherein the light is ambient light, the method further comprising a step of adding artificial light to the volume of interest before or during the step of collecting the ambient light.

20. The method of claim 12, wherein the light is ambient light, the method further comprising intermittently adding light to the ambient light.

21. The method of claim 20, further comprising detecting a photoacoustic response from the volume of interest and interpreting the photoacoustic response.

22. The method of claim 21, wherein interpreting the photoacoustic response further comprises determining a location of a material within the volume of interest.
